(19) United States
(12) Patent Application Publication
(10) Pub. No.: US 2019/0394423 A1
(43) Pub. Date: Dec. 26, 2019

(54) Data Processing Apparatus, Data Processing Method and Storage Medium

(71) Applicant: CASIO COMPUTER CO., LTD., Shibuya-ku (JP)

(72) Inventor: Yoshiki ISHIGE, Hamura-shi (JP)

(73) Assignee: CASIO COMPUTER CO., LTD., Shibuya-ku (JP)

(21) Appl. No.: 16/442,217

(22) Filed: Jun. 14, 2019

(30) Foreign Application Priority Data
Jun. 20, 2018 (JP) 2018-116973

(51) Int. Cl. H04N 5/77; H04N 5/262; H04N 7/18

(52) U.S. Cl. CPC H04N 5/77; H04N 7/183; H04N 5/2628

(57) ABSTRACT

An object is to clarify a correspondence relation between a subject that is an audio source in image data and audio emitted from the subject. When image data having audio data is acquired, this image data having audio data is analyzed so as to identify a subject that is an audio source in the image data. Then, audio data corresponding to the subject identified as the audio source is selected from the acquired successive audio data, and this audio data and the subject are associated with each other. In this case, for example, the audio data corresponding to the subject is outputted in association with the display of the subject that is the audio source, or in other words, in synchronization with the image display.

### CROSS-REFERENCE TO RELATED APPLICATION

This application is based upon and claims the benefit of priority from the prior Japanese Patent Application No. 2018-116973, filed Jun. 20, 2018, the entire contents of which is incorporated herein by reference.

### BACKGROUND OF THE INVENTION

### 1. Field of the Invention

The present invention relates to a data processing apparatus that acquires and processes image data and audio data, a data processing method and a storage medium.

### 2. Description of the Related Art

As an example of a technique for replaying acquired image data and audio data in association with each other by a data processing apparatus (such as a video camera, a compact camera, and a smartphone) that acquires and processes image data and audio data, a technique is known in which, when a circular image (fisheye image) including the face of each participant in a meeting is captured using a wide-angle lens (fisheye lens) capable of performing wide range imaging with a viewing angle of substantially 180 degrees, each participant's face is identified from the captured fisheye image, and a clipped image (partial image) of each participant is displayed with the length of time of each participant's speech, as disclosed in Japanese Patent Application Laid-Open (Kokai) Publication No. 2015-019162.

### SUMMARY OF THE INVENTION

In accordance with one aspect of the present invention, there is provided a data processing apparatus comprising: a processor, wherein the processor performs processing of: acquiring image data; acquiring audio data; analyzing the image data so as to identify a subject that is an audio source in the image data; extracting specific audio data corresponding to the subject identified as the audio source from the acquired audio data; and controlling such that the specific audio data and the subject are associated with each other.

In accordance with another aspect of the present invention, there is provided a data processing method for a data processing apparatus, comprising: acquiring image data; acquiring audio data; analyzing the acquired image data so as to identify a subject that is an audio source in the image data; extracting specific audio data corresponding to the subject identified as the audio source from the acquired audio data; and controlling such that the specific audio data and the subject are associated with each other.

In accordance with another aspect of the present invention, there is provided a non-transitory computer-readable storage medium having stored thereon a program that is executable by a computer in a data processing apparatus to actualize functions comprising: acquiring image data; acquiring audio data; analyzing the acquired image data so as to identify a subject that is an audio source in the image data; extracting specific audio data corresponding to the subject identified as the audio source from the acquired audio data; and controlling such that the specific audio data and the subject are associated with each other.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1A is a diagram showing a data processing apparatus 1 where an imaging device 2 and a main body device 3 have been integrally attached to each other, and FIG. 1B is a diagram showing the data processing apparatus 1 where the imaging device 2 and the main body device 3 have been separated from each other;

FIG. 2 is a block diagram showing basic components of the main body device 3 which constitutes the data processing apparatus 1;

FIG. 3A is a diagram showing a state where the imaging device 2 is in a horizontal orientation, FIG. 3B is a diagram exemplarily showing a fisheye image captured in the horizontal orientation, and FIG. 3C is a diagram exemplarily showing a state where an area including a subject that is an audio source has been clipped from the fisheye image and enlarged and displayed;

FIG. 4 is a flowchart showing an operation (a characteristic operation in a first embodiment: image and audio playback processing) of the data processing apparatus 1 (main body device 3);

FIG. 5 is a flowchart showing a characteristic operation (image and audio playback processing) of the data processing apparatus 1 (main body device 3) in a second embodiment;

FIG. 6A is a diagram exemplarily showing moving image data in a third embodiment, and FIG. 6B is a diagram exemplarily showing a state where audio data (voice data) is outputted in synchronization with the moving image data;

FIG. 7 is a flowchart showing a characteristic operation (image and audio playback processing) of the data processing apparatus 1 (main body device 3) in a third embodiment; and

FIG. 8 is a diagram for describing modification examples of the first to third embodiments, in which moving image data having audio data is transmitted to an external device (a television receiver or a surveillance monitor apparatus) 20 from the data processing apparatus 1, and outputted by the external device 20.

### DETAILED DESCRIPTION OF THE PREFERRED EMBODIMENTS

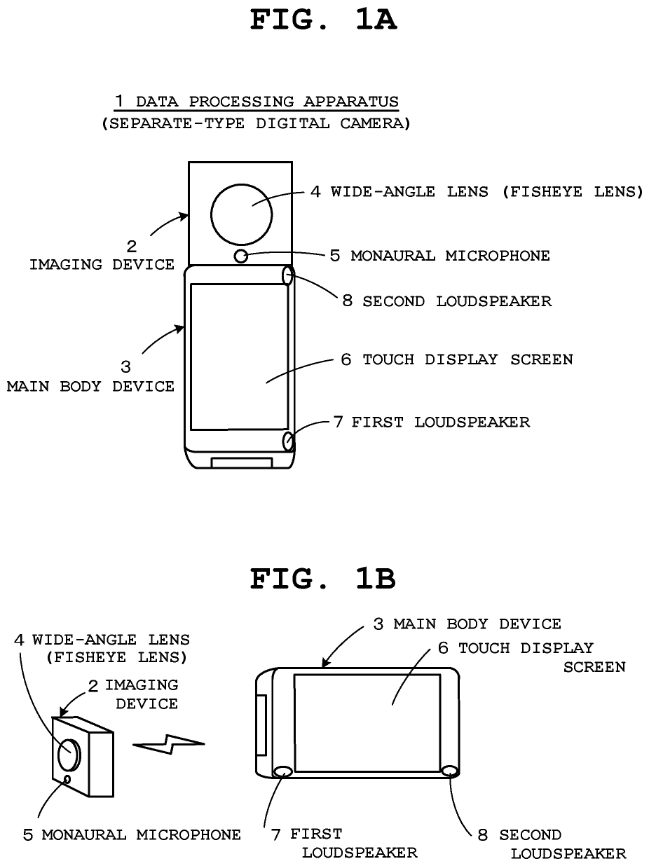

An embodiment of the present invention will hereinafter be described with reference to FIG. 1A to FIG. 4.

In the present embodiment, a separate-type digital camera is exemplarily shown as a data processing apparatus 1 according to the present invention. This data processing apparatus 1, which is the separate-type digital camera, can be separated into an imaging device 2 equipped with an imaging section described later and a main body device 3 equipped with a display section described later. FIG. 1A is a diagram showing the data processing apparatus 1 where the imaging device 2 and the main body device 3 have been integrally attached to each other, and FIG. 1B is a diagram showing the data processing apparatus 1 where the imaging device 2 and the main body device 3 have been separated from each other. Between the imaging device 2 and the main body device 3 constituting the data processing apparatus 1, pairing (wireless connection recognition) can be achieved by using wireless communication usable for each device. As this wireless communication, for example, wireless LAN (Wi-Fi) or Bluetooth (registered trademark) is used.

The imaging device 2 has a recording function in addition to an imaging function capable of capturing still images and moving images, and is configured to transmit image data having audio data acquired at the time of image capturing to the main body device 3 side. This imaging device 2 is equipped with a wide-angle lens (fisheye lens) 4 and a single microphone (monaural microphone) 5 provided near the wide-angle lens. Note that this imaging device 2 has a structure where the wide-angle lens (fisheye lens) 4 can be arbitrarily switched to a standard lens (not shown). The imaging device 2 includes, although not shown in the drawing, a control section which controls the entire operation of the imaging device 2, a power supply section equipped with a secondary battery, a storage section equipped with a ROM (Read Only Memory) and a flash memory, a communication section which performs wireless communication with the main body device 3, the imaging section equipped with the wide-angle lens 4, an audio input section equipped with the monaural microphone 5 and the like.

The wide-angle lens 4 is a fisheye lens capable of performing wide range imaging with a viewing angle of substantially 180 degree. In the present embodiment, half-celestial-sphere images are captured by this fisheye lens. Note that the entire area of each fisheye image (half-celestial-sphere image) is distorted and this distortion gradually becomes larger from its center (optical axis) toward a lens edge (peripheral portion). The monaural microphone 5, which is an ultra-small microphone suitable for beamforming or the like, is provided on the wide-angle lens 4 side and collects surrounding sound in synchronization with image capturing. More specifically, this monaural microphone 5 is a MEMS (Micro Electronics Mechanical System) microphone which is impervious to vibration, shock, and temperature change, and has superior audio and electrical properties. In the present embodiment, a non-directional microphone is used.

When image data having audio data acquired on the imaging device 2 side is received and acquired by the main body device 3, the main body device 3 displays the image data on its monitor screen (live view screen) as a live view image and stores the image data and the audio data in association with each other. This main body device 3 includes a touch display screen 6 having a touch input function and a display function, and two loudspeakers 7 and 8 (dynamic type loudspeakers) which output audio data in synchronization with the display of moving image data. These two loudspeakers 7 and 8 are arranged such that they are separated from each other by a predetermined distance (as much as possible). In the example of the drawing, the two loudspeakers 7 and 8 have been arranged in the rectangular main body device 3 such that they are separated as much as possible from each other in the longer side direction of the main body device 3. In the present embodiment, in the rectangular main body device 3 in a horizontal orientation, the first loudspeaker (left loudspeaker) 7 is located at the lower left corner of the main body device 3, and the second loudspeaker (right loudspeaker) 8 is located at the lower right corner of the main body device 3.

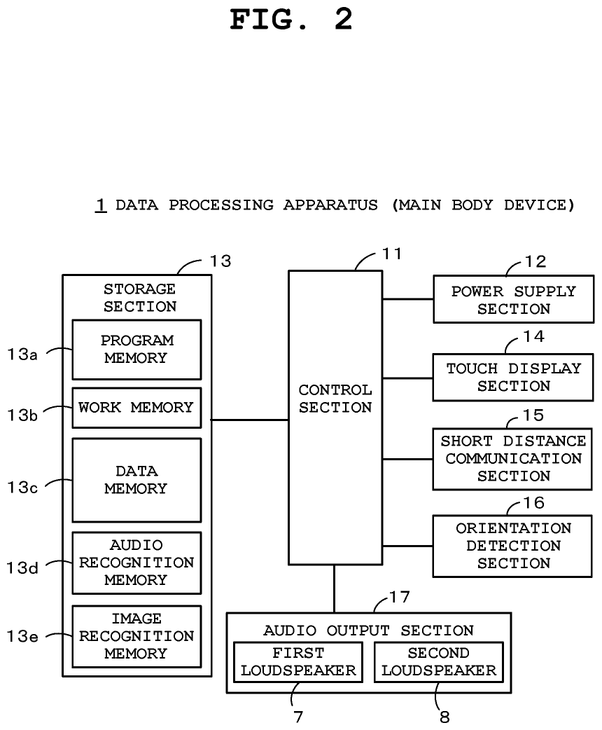

FIG. 2 is a block diagram showing basic components of the main body device 3 constituting the data processing apparatus 1.

The data processing apparatus 1 (main body device 3) includes a control section 11, a power supply section 12, a storage section 13, a touch display section 14, a short distance communication section 15, an orientation detection section 16, and an audio output section 17. Also, the main body device 3 has a data acquisition function for receiving and acquiring image data and audio data from the imaging device 2 via the short distance communication section 15, an image playback function for replaying acquired image data, and an audio playback function for replaying a series of acquired audio data. The control section 11 is operated by power supply from the power supply section (secondary battery) 12 and controls the entire operation of the main body device 3 in accordance with various programs in the storage section 13. This control section 11 includes a CPU (Central Processing Unit), a memory and the like not shown.

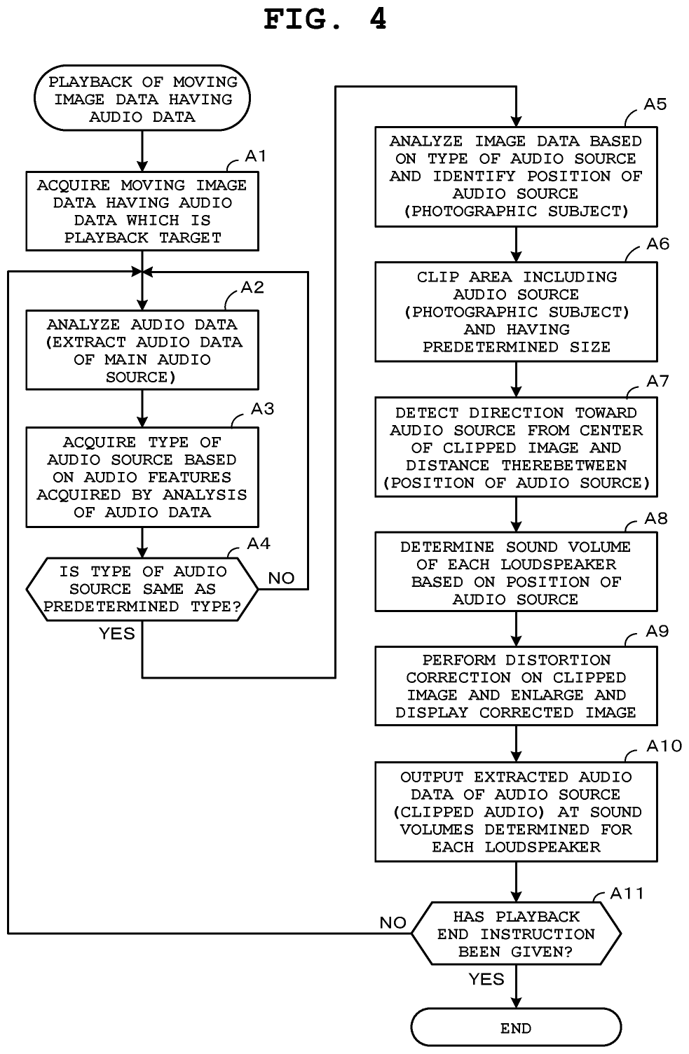

The storage section 13 includes a program memory 13a having stored thereon programs (refer to the flowchart of FIG. 4) and various applications for achieving the present embodiment, a work memory 13b which temporarily stores various information (such as flags) required for the main body device 3 to operate, and a data memory 13c which stores image data having audio data and the like. In the first embodiment, the storage section 13 also includes an audio recognition memory 13d and an image recognition memory 13e described later. Note that the storage section 13 may be structured to include a removable portable memory (recording medium) such as an SD (Secure Digital Card) card or USB (Universal Serial Bus) memory. Also, although not shown, in a case where the data processing apparatus 1 (main body device 3) is connected to a network via a communication function, the storage section 13 may be structured to include a storage area on a predetermined server device side.

The audio recognition memory 13d is used when audio data is analyzed. This audio recognition memory 13d is configured to store, for each audio source, information indicating its audio source type and information indicating its audio features (audio feature amount) which differ for each audio source type in association with each other. The “audio source type” is, for example, a person (a young man, a young woman, an old man, an old woman), an animal (a large dog, a small dog, a cat, a bird), or an object (a car, a train). However, as a matter of course, it is not limited thereto. Note the above-described information in the audio recognition memory 13d is information acquired by a large amount of audio data inputted in advance being statistically processed and audio features such as regularity and relevance in accordance with audio source types being learned and modeled (machine learning such as deep learning), and the contents of which are dynamically and sequentially changed (by adding or editing) in accordance with learning contents.

The image recognition memory 13e is used when image data is analyzed. This image recognition memory 13e is configured to store, for each audio source, information indicating its audio source type and information indicating its appearance features (image feature amount) which differs for each audio source type in association with each other. The “audio source type” is a person (a young man, a young woman, an old man, an old woman), an animal (a large dog, a small dog, a cat, a bird), or an object (a car, a train), as in the case of the audio recognition memory 13d. However, as a matter of course, it is not limited thereto. Note the above-described information in the image recognition memory 13e is information acquired by a large amount of image data inputted in advance being statistically processed and appearance features such as regularity and relevance in accordance with audio source types being learned and modeled (machine learning such as deep learning), and the contents of which are dynamically and sequentially changed (by adding or editing) in accordance with learning contents.

The touch display section 14 has a touch display screen 6 structured by a touch panel being laminated on a display such as a high-definition liquid-crystal display. This touch display screen 6 functions as a monitor screen (live view screen) for displaying a live view image on a real-time basis or a screen for replaying captured images. The short distance communication section 15 is a communication interface which transmits and receives various types of data to and from the imaging device 2 or an external device 20 described later. The orientation detection section 16 is a triaxial acceleration sensor or the like which detects acceleration applied to the main body device 3. This orientation detection section 16 detects, as the orientation of the main body device 3, whether the screen is a vertically-elongated screen (vertically-oriented screen) or a horizontally-elongated screen (horizontally-oriented screen) in accordance with the orientation of the rectangular touch display section 14, and provides the detection result to the control section 11. The audio output section 17 includes the first loudspeaker 7 and the second loudspeaker 8 which output sound based on audio data.

The output sound volumes of the loudspeakers 7 and 8 are controlled for each loudspeaker.

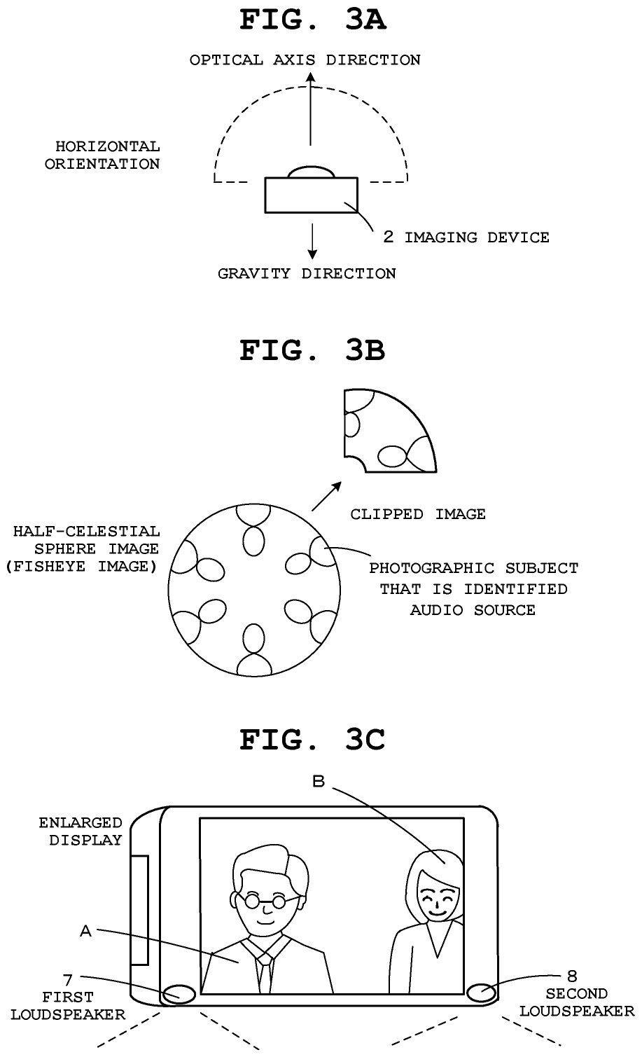

FIG. 3A is a diagram showing a state where the imaging device 2 is in a horizontal orientation.

More specifically, FIG. 3A shows an orientation of the imaging device 2 (horizontal orientation) when image capturing is performed with the wide-angle lens 4 being oriented to the zenith (horizontal orientation state), that is, when image capturing is performed with the optical axis direction (image capturing side) being substantially opposite to the gravity direction. FIG. 3B is a diagram exemplarily showing a fisheye image captured by the imaging device 2 in the horizontal orientation. More specifically, FIG. 3B shows a fisheye image (half-celestial sphere image) of a meeting captured by the imaging device 2 placed in the horizontal orientation on a table during the meeting, in which a plurality of persons are shown to be circularly positioned. FIG. 3C is a diagram showing a state where a predetermined area including subject A that is an audio source (speaker) has been clipped from the fisheye image and enlarged and displayed on the touch display screen 6 by the data processing apparatus 1 (main body device 3).

In the example of FIG. 3B, a partial image is clipped from a fisheye image captured in the horizontal orientation state where the optical axis direction corresponds to the zenith direction, and displayed on the horizontally-elongated screen (horizontally-oriented screen). However, this image enlarged and displayed on the touch display screen 6 may be a partial image clipped from a fisheye image captured in the vertical orientation state where the optical axis direction corresponds to the horizontal direction, and displayed on the horizontally-elongated screen (horizontally-oriented screen) or the vertically-elongated screen (vertically-oriented screen).

When a playback target is arbitrarily specified by a user operation for the playback of image data having audio data, the control section 11 of the main body device 3 reads and acquires the specified image data having audio data from the data memory 13c. Then, the control section 11 starts the playback of the image data having audio data in response to the user's playback instruction. Here, in the first embodiment, the control section 11 does not perform the sequential playback (full playback) of the whole image data having audio data. The control section 11 sequentially analyzes the audio data, detects each audio segment excluding its preceding and following silent segments, extracts audio data and image data corresponding to this audio segment, and replays only the extracted audio data and image data in association with each other (partial playback).

That is, when the series of audio data is sequentially analyzed and each audio segment excluding its preceding and following silent segments is detected, the control section 11 performs processing of extracting the features of audio data corresponding to this audio segment, and thereby acquires the audio features (frequency property and the like) of the audio segment. Next, the control section 11 acquires an audio source type corresponding to the audio features with reference to the audio recognition memory 13d, and then identifies an audio source (subject) having audio features which correspond to the audio source type with reference to the image recognition memory 13e. Then, the control section 11 clips an area of a predetermined size including the identified audio source (subject) from a playback target image, performs distortion correction on the clipped image, and enlarges and displays the clipped image. Note that any image clipping method may be used here. In the example of FIG. 3C, image clipping where another subject B (subject seated next to subject (male) A) is included as much as possible has been performed.

Then, from the series of audio data specified as a playback target, the control section 11 selects (extracts) audio data corresponding to the audio source (subject) identified as described above, and clips this audio data as audio data corresponding to the audio source (subject). In addition, the control section 11 controls such that this clipped audio (trimming audio) and the clipped image are associated with each other (the clipped audio and the image display are synchronized with each other), and causes the audio output section 17 to output them. Here, the control section 11 controls the output status (output sound volume) of the clipped audio for each loudspeaker, in accordance with the position (displayed position) of the audio source (subject) in the clipped image. More specifically, the control section 11 detects a direction from the center of the clipped image (plane) toward the audio source (subject) and a distance (a position in a plane coordinate system) from the center to the audio source (subject), and individually controls the sound volumes of the clipped audio that is outputted from the loudspeakers 7 and 8 based on whether the display position of the audio source (subject) is on the first loudspeaker 7 side or on the second loudspeaker 8 side.

In the example in the drawing, the position of audio source (subject) A is on the first loudspeaker 7 side (left side in the drawing) with respect to the center of the clipped image. In this case, the control section 11 controls such that the output sound volume of the first loudspeaker 7 for subject A is louder than a sound volume (set sound volume) arbitrarily set in advance, and the output sound volume of the second loudspeaker 8 for subject A is softer than the set sound volume. In this sound volume control, the output sound volumes of the loudspeakers 7 and 8 are controlled such that, as the distance from the center of the clipped image to the position of the audio source increases, that is, as the audio source approaches the loudspeaker arranged on the audio source side, the output sound volume of this loudspeaker is increased and the output sound volume of the other loudspeaker is decreased.

Next, the operation concept of the data processing apparatus 1 (main body device 3) in the first embodiment is described with reference to the flowchart shown in FIG. 4. Here, each function described in these flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later. FIG. 4 is a flowchart outlining the operation of the characteristic portion of the present embodiment from among all of the operations of the data processing apparatus 1. After exiting the flow of FIG. 4, the control section 11 returns to the main flow (omitted in the drawings) of the overall operation.

The flowchart of FIG. 4 shows an operation (a characteristic operation in the first embodiment: image and audio playback processing by the control section 11) of the data processing apparatus 1 (main body device 3), which is started when an instruction to replay image data having audio data is given. Note that the flowchart herein is described using a case where moving image data with audio data stored by moving image capturing has been specified as a playback target (the same applies hereinafter).

First, when a playback instruction is given, the control section 11 reads out and acquires the audio data and the moving image data specified as the above-described playback target from the data memory 13c (Step A1). Next, the control section 11 sequentially analyzes this successive audio data and, in each analysis, extracts the audio data of an audio source therefrom as clipped audio data (Step A2). More specifically, in each audio segment excluding its preceding and following silent segments, the control section 11 extracts an audio source whose sound pressure level is higher than a predetermined value as a main audio source, and thereby acquires, as clipped audio, the audio data of the main audio source where noise has been removed.

Then, by analyzing the clipped audio (the audio data of the main audio source), the control section 11 acquires the audio features of the audio source, and performs processing for acquiring the type of the audio source having these audio features with reference to the audio recognition memory 13d (Step A3). Here, the control section 11 analyzes the audio data by use of a statistical method or the HMM (Hidden Markov Model) method. More specifically, by use of HMM that defines the probability of transition from a current state to the next state, the clipped audio is analyzed, and the type of the audio source is identified by pattern matching of time-series audio features acquired thereby and models of these time-series audio features.

Next, the control section 11 judges whether the type of the audio source has been identified as a predetermined type as a result of the audio analysis (Step A4). That is, the control section 11 judges whether the audio features acquired by analyzing the audio data correspond to an audio source type stored in the audio recognition memory 13d. For example, in a case where the audio source is a person, the control section 11 further judges whether the audio source is a young man, a young woman, an old man or an old woman. In a case where the audio source is an animal, the control section 11 further judges whether the audio source is a dog (a large dog, a small dog), a cat, or a little bird. In a case where the audio source is an object, the control section 11 further judges whether the audio source is a car or a train.

Here, when the identified type of the audio source is not the same as a predetermined type (NO at Step A4), the control section 11 returns to the above-described audio analysis processing (return to Step A2) so as to disregard the clipped audio (so as to set such that the clipped audio is not outputted). Also, when the identified type is the same as a predetermined type (YES at Step A4), the control section 11 analyzes the corresponding image data based on the type of the audio source so as to identify a point where the subject that is the audio source is positioned in the image (the position of the subject) (Step A5). That is, the control section 11 acquires subject appearance features corresponding to the type of the audio source by referring to the image recognition memory 13e based on the type of the audio source, and identifies the position of the subject (audio source) who has these appearance features by analyzing the image data.

As an image analysis method therefor, for example, a method may be used in which analysis is performed by a combination of a partial characteristic amount and a statistical learning technique. In the present embodiment, a configuration has been adopted in which, as an algorithm for object (audio source) detection, the R-CNN (Regions with CNN features) method is used to identify an audio source in an image. More specifically, in the sequential analysis of time-series frame images, an object (audio source) candidate (Region Proposals) is searched for in an image by use of an existing method (Selective Search) of searching for a similarity (Objectness) to an object (audio source). Subsequently, an area image corresponding to this audio source candidate is resized to have a predetermined size, and inputted in the CNN (Convolutional Neural Network) so as to extract appearance features of the audio source. Then, the extracted appearance features of the audio source are learned using a plurality of SVM (Support Vector Machine), and Bounding Box (the position of the audio source (subject)) is estimated by category identification and regression analysis.

When the position of the audio source (subject) in the image is identified as described above, the control section 11 clips an area including the audio source (subject) and having a predetermined size (for example, a quarter of the size of the whole image) from the moving image (fisheye image) data (Step A6). Here, the control section 11 clips the predetermined size area in a manner to include subjects as many as possible in addition to merely positioning the audio source (subject) at the center of the image. For example, when another subject such as another person is present next to the audio source, the predetermined size area is set and clipped such that this subject is also included. Also, the predetermined size area is set and clipped in consideration of its composition with a background. Note that the manner of clipping the predetermined size area is not limited to these examples, and may be arbitrarily determined.

Here, the explanation of the flowchart is continued using an example where an area including male subject A that is an audio source (speaker) and another subject (a woman sitting next to the audio source) B have been clipped from a fisheye image (half-celestial sphere image) captured in the horizontal orientation, as shown in FIG. 3A to FIG. 3C. After clipping this area, the control section 11 detects a direction toward the audio source (subject) from the center of the clipped image and a distance therebetween, as the position of subject (male) A that is the audio source in the clipped image (Step A7). More specifically, the control section 11 detects in which direction male subject A serving as the audio source (speaker) is located from the center of the clipped image and how far it is from this center in the clipped image. That is, the control section 11 detects, in the clipped image, how close the audio source is to the first loudspeaker 7 from the center of the clipped image and how close it is to the second loudspeaker 8.

Next, the control section 11 determines the output sound volume of the above-described clipped audio based on the detected position of the audio source (subject) (Step A8). That is, in FIG. 3C, subject (male) A serving as the audio source (speaker) is significantly close to the first loudspeaker 7 (left side in the drawing). Therefore, the control section 11 determines the output volume of the clipped audio for each loudspeaker such that the output sound volume of the clipped audio to be outputted from the first loudspeaker 7 is louder than the set sound volume by an amount equal to the closeness and, conversely, the output sound volume of the clipped audio to be outputted from the second loudspeaker 8 is softer than the set sound volume by an amount equal to the farness.

Then, the control section 11 performs distortion correction processing on the clipped image by the wide-angle lens (fisheye lens) 4, and then performs processing for enlarging the corrected image to have a size corresponding to the entire touch display screen 6 for display (Step A9). In addition, the control section 11 controls such that the clipped audio and the display of the clipped image are associated (synchronized) with each other, and outputs the clipped audio from the loudspeakers 7 and 8 at the sound volumes determined for each loudspeaker (Step A10). In the case of FIG. 3C, the position of the audio source (subject) in the clipped image is significantly close to the first loudspeaker 7 (left side in the drawing), so that the output sound volume of the first loudspeaker 7 is increased in proportion to the closeness and, conversely, the output sound volume of the second loudspeaker 8 is decreased in proportion to the farness.

When the processing is performed in which the output sound volumes for the clipped audio are controlled for each loudspeaker based on the position of the audio source (subject), the control section 11 judges whether the playback has been completed, that is, the playback of the moving image data having the audio data has been completed, or judges whether a playback end instruction has been given by a user operation during the playback (Step A11). When the playback has not been completed (NO at Step A11), the control section 11 repeatedly returns to the above-described processing Step A2 and repeats the above-described processing until the playback is completed. Here, in a case where the identified audio source (subject) is a moving object or is a subject captured by a moving photographer, the output status (output sound volumes) of the clipped audio is controlled based on the movement of the position of the audio source by the above-described processing being repeated.

Note that, as a matter of course, a configuration may be adopted in which a processing step of creating a file for managing clipped audio and a clipped image corresponding thereto is newly provided to be performed after the above-described processing Step A6, and each processing after the above-described processing Step A7 is performed using the management file created in this new processing step.

As described above, in the first embodiment, when image data and audio data are acquired, the control section 11 of the data processing apparatus 1 (main body device 3) analyzes this acquired image data so as to identify a subject that is an audio source in the image. In addition, the control section 11 selects audio data corresponding to the subject identified as an audio source from the acquired successive audio data, and controls such that the audio data and the subject are associated with each other. As a result of this configuration, a relation between a subject that is an audio source and present in an image and audio emitted from the subject can be clarified.

Also, the control section 11 analyzes acquired successive audio data so as to identify audio features of an audio source, and analyzes acquired image data based on the audio features so as to identify a subject having these audio features. As a result of this configuration, a subject that is an audio source and present in an image can be accurately identified based on audio data.

Moreover, the control section 11 displays image data including a subject identified as an audio source, and controls such that the audio data of the audio source and the displayed subject are associated with each other. As a result of this configuration, the audio data of a displayed audio source (subject) and this audio source can be associated with other, whereby a correspondence relation therebetween can be clarified.

Furthermore, in a state where an area including a subject identified as an audio source has been clipped from acquired image data and displayed, the control section 11 selects audio data corresponding to the subject that is being displayed as an audio source from acquired audio data, and controls such that the audio data and this subject are associated with each other. As a result of this configuration, based on a subject identified as an audio source, an area including the subject can be clipped, and a correspondence relation between the subject (audio source) in the clipped image and audio emitted from the subject (audio source) can be clarified.

Still further, when selected audio data of an audio source (subject) is to be outputted, the control section 11 controls the output status of the audio in accordance with the position of the audio source in an image. As a result of this configuration, audio output conforming with the position of an audio source can be performed, by which realistic audio can be outputted.

Yet still further, the main body device 3 has the first loudspeaker 7 and the second loudspeaker 8 as a plurality of speakers arranged at different positions and, when the audio data of an audio source (subject) is to be outputted, the control section 11 controls output sound volumes for each loudspeaker. As a result of this configuration, more realistic audio can be outputted.

Yet still further, when an identified audio source is a moving object or is an object captured by a moving photographer, the control section 11 controls the output status (sound volumes) of audio data for each loudspeaker based on the movement of the position of the audio source. As a result of this configuration, more realistic audio can be outputted.

Yet still further, when audio data is to be outputted, the control section 11 selects (extracts) and outputs only audio data corresponding to a subject identified as an audio source (extraction), and thereby prevents the other audio data acquired with the audio data from being outputted. As a result of this configuration, clear audio where noise and the like have been eliminated can be outputted.

Yet still further, the image data of the present embodiment is images (fisheye images) acquired by wide-angle image capturing, and the audio data thereof is audio acquired and stored in synchronization with the wide-angle image capturing. As a result of this configuration, even in a fisheye image where many subjects are highly likely present, a subject that is an audio source can be easily identified by acquired audio data being analyzed.

### Second Embodiment

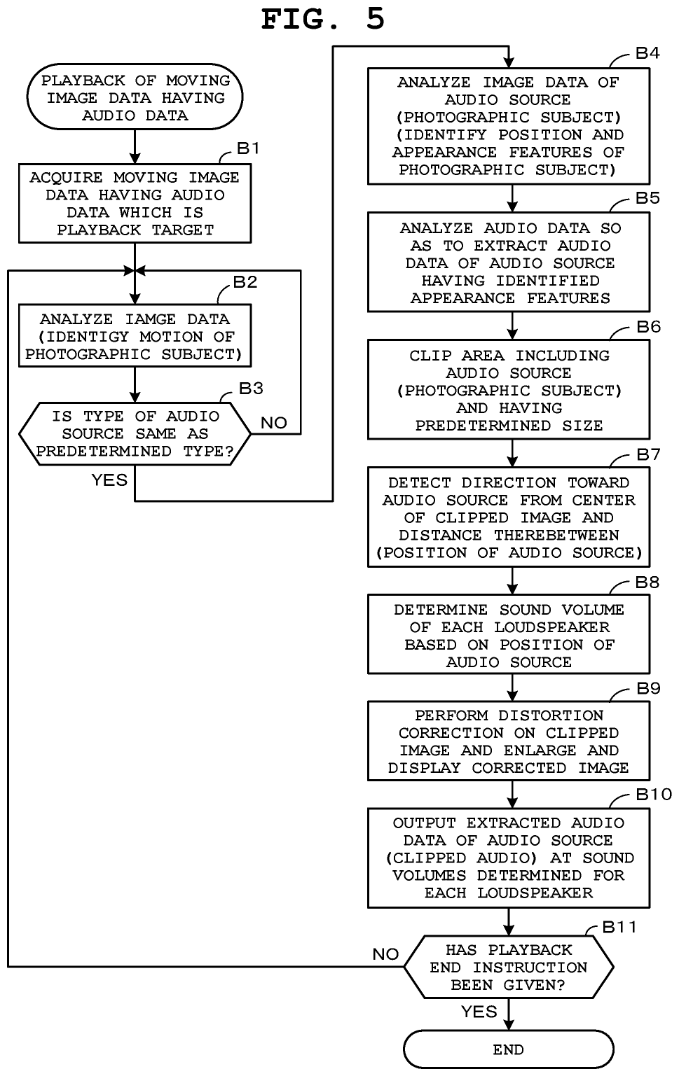

A second embodiment of the present invention will hereinafter be described with reference to a flowchart in FIG. 5.

In the above-described first embodiment, audio analysis is performed, and then image analysis is performed, whereby a clipped image and audio are associated with each other.

However, in the second embodiment, image analysis is performed, and then audio analysis is performed, whereby a clipped image and audio are associated with each other. Here, sections that are basically the same as those of the first embodiment or sections having the same name in both embodiments are given the same reference numerals and descriptions thereof are omitted. Hereafter, the characteristic portions of the second embodiment are mainly described.

FIG. 5 is a flowchart showing a characteristic operation (image and audio playback processing by the control section 11) of the data processing apparatus 1 (main body device 3) in the second embodiment, which is started when an instruction to replay image data having audio data is given.

First, when a playback instruction is given, the control section 11 reads out and acquires audio data and moving image data specified as a playback target from the data memory 13c (Step B1). Next, the control section 11 sequentially analyzes each frame of the acquired moving image data, and identifies a subject emitting sound (such as a person who is talking or a dog that is barking) as an audio source, based on all movements or mouth motions of each subject in the moving image (Step B2). Here, when identifying an audio source in the moving image, the control section 11 uses the R-CNN method as an algorithm for object (audio source) detection.

In each analysis of the sequential analysis, the control section 11 judges whether a subject that is an audio source has been identified (Step B3). When no audio source (subject) has been identified, that is, when no subject is emitting sound (NO at Step B3), the control section 11 returns to the above-described image analysis processing (returns to Step B2) so as to disregard the current analysis target image (so as to set such that this image is not outputted). When an audio source (subject) is identified (YES at Step B3), the control section 11 further analyzes the image data including this audio source (subject) so as to perform processing of identifying the position of the audio source (subject) and the appearance features (image feature amount) thereof (Step B4).

Next, the control section 11 analyzes the acquired successive audio data so as to select (extract) the audio data of the audio source (subject) having the identified appearance features from the successive audio data (Step S5). Here, the control section 11 refers to the image recognition memory 13e based on the identified appearance features, and acquires an audio source type corresponding to the appearance features. In addition, the control section 11 refers to the audio recognition memory 13d based on the audio source type, and acquires audio features corresponding to the audio source type. Then, the control section 11 analyzes the acquired successive audio data so as to extract audio data having these audio features, whereby clipped audio is acquired. That is, by selecting (extracting) audio data corresponding to the identified audio source (subject), the control section 11 acquires this audio data as clipped audio (trimming audio).

Then, the control section 11 proceeds to processing corresponding to Step A6 to Step A11 in FIG. 4 (Step B6 to Step B11). First, the control section 11 clips an area having a predetermined size and including the audio source (subject) from the moving image data (Step B6), and performs processing of detecting a direction toward the audio source (subject) from the center of this clipped image and a distance therebetween (the position of the subject) (Step B7) and processing of determining the sound volume of the clipped audio for each loudspeaker in accordance with the position of the audio source (subject) (Step B8). Subsequently, the control section 11 performs distortion correction processing on the clipped image, and then enlarges this clipped image to a size corresponding to the whole touch display screen 6 for display (Step B9).

Then, when outputting the clipped audio in association (synchronization) with image display, the control section 11 controls the output sound volume of the clipped audio for each loudspeaker in accordance with the position of the audio source (subject) (Step B10). When this output processing is ended, the control section 11 judges whether the playback has been completed. That is, the control section 11 judges whether the playback of the moving image data having the audio data has been performed to the end or whether an instruction to end the playback has been given by a user operation during the playback (Step B11). When the playback has not been ended (NO at Step B11), the control section 11 repeatedly returns to the above-described processing Step B2 and repeats the above-described operations until the playback is ended.

Note that, as a matter of course, a configuration may be adopted in which a processing step of creating a file for managing clipped audio and a clipped image corresponding thereto is newly provided to be performed after the above-described processing Step B6, and each processing after the above-described processing Step B7 is performed using the management file created in this new processing step.

As described above, in the second embodiment, the control section 11 analyzes motions of subjects in acquired image data so as to identify a subject that is an audio source, analyzes audio data based on the appearance features of the identified audio source so as to select (extract) audio data corresponding to the appearance features as audio data of the audio source (subject), and controls such that the audio data and the subject are associated with each other. As a result of this configuration, a relation between a subject serving as an audio source in images and audio emitted by the subject can be clarified.

Also, in the second embodiment as well, advantageous effects similar to those of the first embodiment can be acquired. That is, based on a subject identified as an audio source, an area including the subject can be clipped, and a correspondence relation between the subject (audio source) in the clipped image and audio (clipped audio) emitted from the subject (audio source) can be clarified. Also, the output status of the clipped audio can be controlled in accordance with the position of the audio source (subject), and the output sound volume thereof can be controlled for each loudspeaker. Moreover, the output status of the clipped audio can be controlled based on the movement of the position of the audio source.

### Modification Example 1 of First and Second Embodiments

In the configurations of the above-described first and the second embodiments, based on a subject identified as an audio source in acquired image data, an area including the subject is clipped and displayed. However, a configuration may be adopted in which an area to be clipped can be arbitrarily specified by a user operation. Specifically, when an area including a subject serving as an audio source is arbitrarily specified in displayed image data by a user operation, the image of the specified area is clipped and displayed. In this configuration, only by the user arbitrarily specifying an intended subject in a displayed image, this subject and audio data emitted from the subject can be associated with each other.

### Modification Example 2 of First and Second Embodiments

In the configurations of the above-described first and the second embodiments, only the audio data (clipped audio) of an audio source (subject) is extracted and outputted (the other audio data are controlled not to be outputted). However, a configuration may be adopted in which a segment where audio has been generated by an audio source is extracted and outputted without the data of clipped audio being separated therefrom.

In this configuration, an imaging situation including noise can be replayed as it is.

### Modification Example 3 of First and Second Embodiments

In the configurations of the above-described first and the second embodiments, a moving image captured by the wide-angle lens (fisheye lens) 4 capable of performing wide range imaging with a viewing angle of substantially 180 degrees is acquired.

However, the present invention may adopt a configuration in which two fisheye lenses are arranged on the front and rear sides of the imaging device 2, respectively, and image capturing for the range of 180 degrees in the front direction by the front fisheye lens and image capturing for the range of 180 degrees in the rear direction by the rear fisheye lens are performed simultaneously. In this case, a configuration may be adopted in which 360-degree sound collection is performed by the monaural microphone 5 provided on the front side of the imaging device 2 and, when a subject serving as an audio source is located in a direction opposite to the monaural microphone 5 provided on the front side, the audio data of the audio source is virtualized to be outputted as if the audio source is located behind the viewer. This virtualization is achieved by, for example, the binaural technique by which a listener perceives sound as that from an arbitrary direction, or a common method such as processing (crosstalk cancellation processing) of reducing a phenomenon (crosstalk component) where the sound of each channel goes to an ear on an opposite side.

Also, in the above-described first and second embodiments, sound is collected using the single monaural microphone 5. However, a configuration may be adopted in which sound is collected using microphones of two or more channels. In this configuration, the output sound volume of acquired audio data is controlled for each microphone in accordance with the position of an audio source (subject), as in the cases of the first and second embodiments.

### Third Embodiment

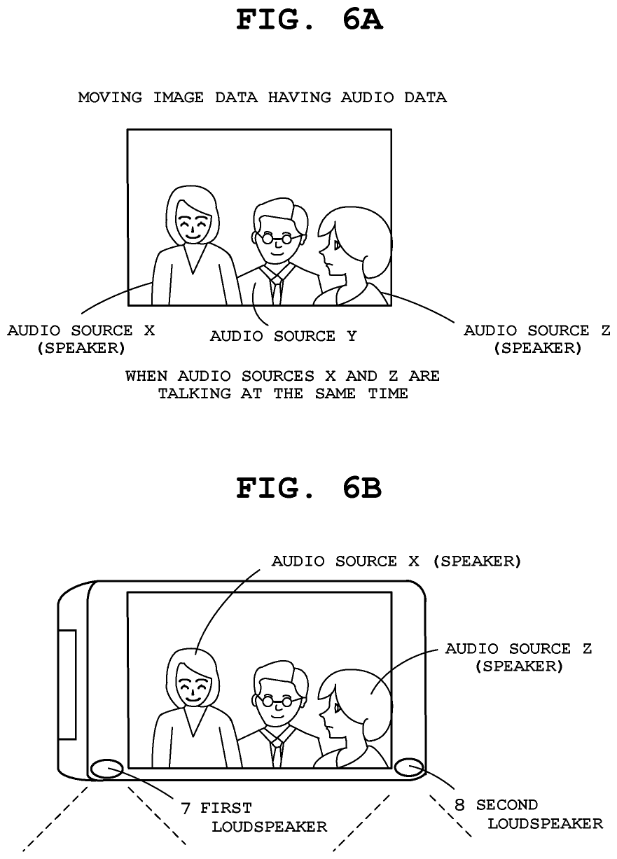

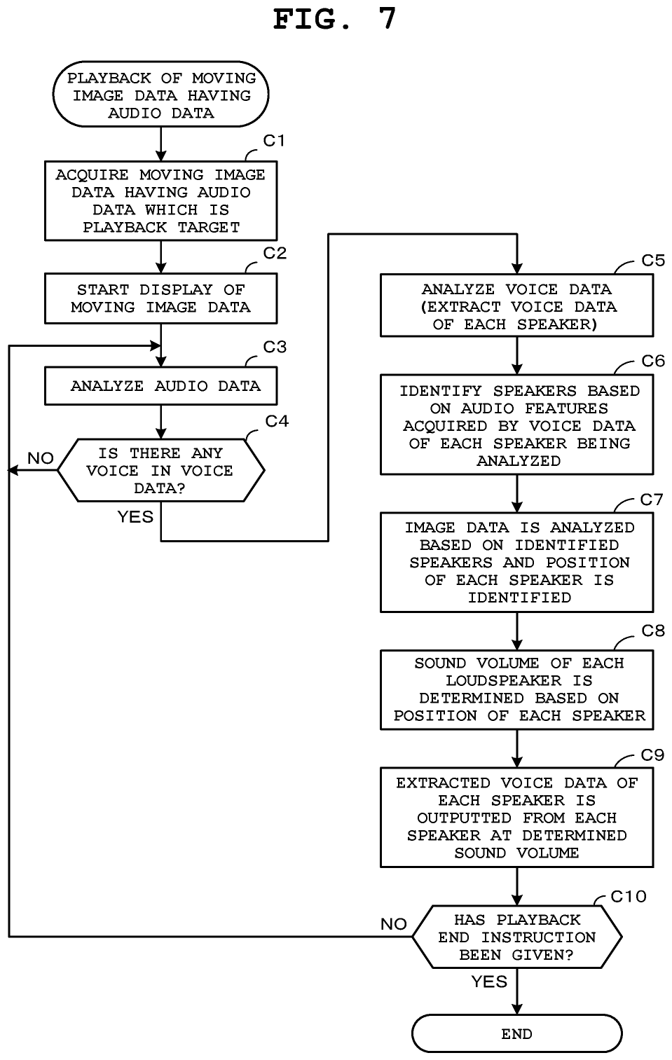

A third embodiment of the present invention will hereinafter be described with reference to FIG. 6A, FIG. 6B and FIG. 7.

In the configuration of the above-described first embodiment, audio data corresponding to the type of an audio source is extracted from acquired successive audio data. However, in the third embodiment, audio data corresponding to each audio source (specific speaker in the case of persons) is extracted from acquired successive audio data. More specifically, in the third embodiment, acquired successive audio data are analyzed so as to extract audio data for each audio source, and audio data corresponding to a subject identified as an audio source is selected from the audio data extracted for each audio source and associated with the subject. Note that sections that are basically the same as those of the first embodiment or sections having the same name in both embodiments are given the same reference numerals and descriptions thereof are omitted. Hereafter, the characteristic portions of the third embodiment are mainly described.

FIG. 6A is a diagram exemplarily showing moving image data in a third embodiment. In the above-described first embodiment, the image captured using the wide-angle lens (fisheye lens) 4 has been exemplarily shown. However, in the third embodiment, an image captured using a standard lens (not shown in the drawing) is exemplarily shown, which shows three people X, Y and Z having a conversation with one another in the example in the drawing. Here, the image data thereof has been stored in the data memory 13c together with audio data acquired by the monaural microphone 5 at the time of the image capturing. Note that, at the imaging timing of the shown image, both persons (two women) X and Z had been talking.

FIG. 6B is a diagram exemplarily showing a state where the audio data (voice data) is outputted in synchronization with the display of the moving image data shown in FIG. 6A.

In the configurations of the first and second embodiments described above, an area including an audio source (subject) is clipped and displayed as a portion of acquired image data. However, in the third embodiment, the whole acquired image data is displayed. In the shown example, the audio data of two women X and Z who are talking at the same time has been replayed by each loudspeaker 7 and 8 simultaneously. In the third embodiment, in which direction and how far each speaker (audio source) is located from the center of an image are detected, and output sound volumes for each speaker (audio source) are controlled for each loudspeaker in accordance with the detection results (the position of each speaker).

The audio recognition memory 13d in the third embodiment is configured to associate, for each audio source, information (sound source ID) for identifying a sound source with audio features (audio feature amount) and store them. Similarly, the image recognition memory 13e in the third embodiment is configured to associate, for each audio source, a sound source ID with appearance features (image feature amount) and store them. In the above-described first and second embodiments, sound sources are identified by their types (a person, an animal, an object). However, in the third embodiment, sound sources are limited to individual persons (individuals), and audio data is identified based on human voice (voice data).

FIG. 7 is a flowchart showing a characteristic operation (image and audio playback processing by the control section 11) of the data processing apparatus 1 (main body device 3) in the third embodiment, which is started when an instruction to replay moving image data having audio data (voice data) is given.

First, when a playback instruction is given, the control section 11 acquires moving image data having voice data specified as a playback target from the data memory 13c (Step C1), and starts the playback of the moving image data (Step C2). Then, the control section 11 sequentially analyzes the acquired serial voice data (Step C3), and judges whether any voice (human voice) exists therein (Step C4).

When no voice is detected or audio from a non-human is detected (NO at Step C4), the control section 11 returns to the above-described processing Step C3. If any voice is detected (YES at Step C4), the control section 11 analyzes the acquired serial voice data so as to extract the voice data of each speaker (Step C5). Here, the control section 11 performs, for example, a common method such as clustering processing of classifying the voice data of each speaker acquired by the analysis of the serial voice data, and extracts individual voice data for each speaker (extracts the voice data of each person).

Then, the control section 11 refers to the audio recognition memory 13d based on the extracted voice data (audio features) of each speaker, and identifies each specific speaker (audio source ID) corresponding to these audio features (Step C6). Also, the control section 11 refers to the image recognition memory 13e based on each specific speaker (audio source ID), and acquires appearance features corresponding to each specific speaker (audio source ID). In addition, the control section 11 analyzes the acquired image data so as to identify the positions (positions in the image) of the subjects (speakers) having these appearance features (Step C7).

Next, the control section 11 determines, for each loudspeaker, the output sound volume of the voice data of each speaker in accordance with the position of each speaker (Step C8). For example, in the case of the example shown in FIG. 6B, speaker X is on the first loudspeaker 7 side (left side in the drawing) with respect to the center of the image. Accordingly, the control section 11 determines the sound volumes of the first and second loudspeakers 7 and 8 such that the output sound volume of the first loudspeaker 7 is louder than a set sound volume and the output sound volume of the second loudspeaker 8 is softer than the set sound volume. Also, speaker Z is on the second loudspeaker 8 side (right side in the drawing) with respect to the center of the image. Accordingly, the control section 11 determines the sound volumes of the first and second loudspeakers 7 and 8 such that the output sound volume of the second loudspeaker 8 is louder than the set sound volume and the output sound volume of the first loudspeaker 7 is softer than the set sound volume.

Next, the control section 11 controls the loudspeakers to output the extracted voice data of each speaker at the respective determined sound volumes in synchronization with the image display (Step C9). Here, in the case of voices simultaneously uttered by a plurality of speakers, a mixed voice acquired by the voice data of the speakers being combined is outputted for each loudspeaker. More specifically, in the case of the example shown in FIG. 6B, a mixed voice of speakers X and Y from the first loudspeaker 7 is outputted such that the voice of speaker X is outputted at a sound volume louder than that of the voice of speaker Z, and a mixed voice of speakers X and Y from the second loudspeaker 8 is outputted such that the voice of speaker Z is outputted at a sound volume louder than that of the voice of speaker X. Then, the control section 11 judges whether a playback end instruction has been given. Specifically, the control section 11 judges whether the playback of the moving image data having the voice data has been performed to the end or whether an instruction to end the playback has been given by a user operation during the playback (Step C10). When the playback has not been ended (NO at Step C10), the control section 11 repeatedly returns to the above-described processing Step C3 and repeats the above-described operations until the playback is ended.

Note that, as a matter of course, a configuration may be adopted in which a processing step of creating a file for managing voice data extracted for each speaker and image data including these speakers is newly provided to be performed after the above-described processing Step C6, or a processing step of creating a file for managing voice data extracted for each speaker, image data including these speakers, speaker position information, identified-speaker information, and the like is newly provided to be performed after the above-described processing Step C7, and each processing thereafter is performed using the management file created in this new processing step.

As described above, in the third embodiment, acquired successive audio data are analyzed so as to extract the audio data of each audio source, and the audio data of audio sources (subjects) are selected from the extracted audio data and associated with the subjects. As a result of this configuration, audio sources (subjects) can be accurately identified. Accordingly, an association between an audio source and a subject can be unfailingly achieved.

Also, the control section 11 analyzes displayed image data and identifies each subject that is an audio source in the image. As a result of this configuration, extracted audio data of each audio source and each displayed audio source (subject) can be associated with other, so that each correspondence relation becomes clear.

Moreover, when a plurality of speakers are talking simultaneously, the main body device 3 outputs extracted voice data of the speakers as mixed sound for each loudspeaker. As a result of this configuration, clear voice sound can be outputted even when a plurality of speakers are talking simultaneously.

Furthermore, the third embodiment has the same advantageous effect as the above-described first embodiment. That is, based on the position of a displayed subject (speaker) that is an audio source, the output volume of the voice data of the speaker can be controlled for each loudspeaker. In addition, this output volume can be controlled based on the movement of the position of the audio source (speaker).

### Modification Example 1 of Third Embodiment

In the configuration of the third embodiment described above, each speaker is identified based on the voice data (audio feature) of each speaker extracted from acquired voice data, and then the positions of the subjects (speakers) are identified from the appearance features of the speakers. However, the present invention is not limited thereto. For example, a configuration may be adopted in which, by the analysis of acquired image data, each speaker is identified based on the appearance features thereof, their positions are identified, and then the voice data of each speaker is extracted by acquired voice data being analyzed based on the audio features of each speaker. That is, as the relation between the first embodiment and the second embodiment described above, either one of the configurations where image analysis is performed after audio analysis or audio analysis is performed after image analysis can be adopted.

### Modification Example 2 of Third Embodiment

In the configuration of the third embodiment described above, voice data is acquired by the single monaural microphone 5. However, for example, a configuration may be adopted in which a microphone (not shown) is worn on each participant of a meeting, and voice data is acquired from each microphone. In this configuration, a subject (speaker) in an image is identified during the display of moving image data, and the voice data of the audio source (speaker) is selected from voice data acquired from each microphone, and associated with this subject (speaker). By this configuration where a microphone is worn on each participant, clustering processing becomes unnecessary in which voice data is analyzed and classified by speaker.

### Modification Example 3 of Third Embodiment

In the configuration of the third embodiment described above, the voice data of each speaker is extracted during the playback of moving image data. However, a configuration may be adopted in which processing where the voice data of each speaker is extracted and stored is performed as preprocessing that is performed before the start of the playback of moving image data, and voice data is outputted in synchronization with the appearance (display timing) of a speaker during the display of the moving image data. Also, in the third embodiment, audio sources (subjects) are persons. However, as a matter of course, the present invention is not limited thereto.

### Modification Example 1 of First to Third Embodiments

In the configurations of the first to third embodiments described above, only the audio data of an audio source (subject) is extracted and outputted. However, a configuration may be adopted in which audio data are stored with them being classified into the audio data of an audio source (subject) and the audio data of others including noise simultaneously acquired with the audio data of the audio source, and the audio data of the audio source (subject) is outputted after being combined with the audio data of the noise and the like.

### Modification Example 2 of First to Third Embodiments

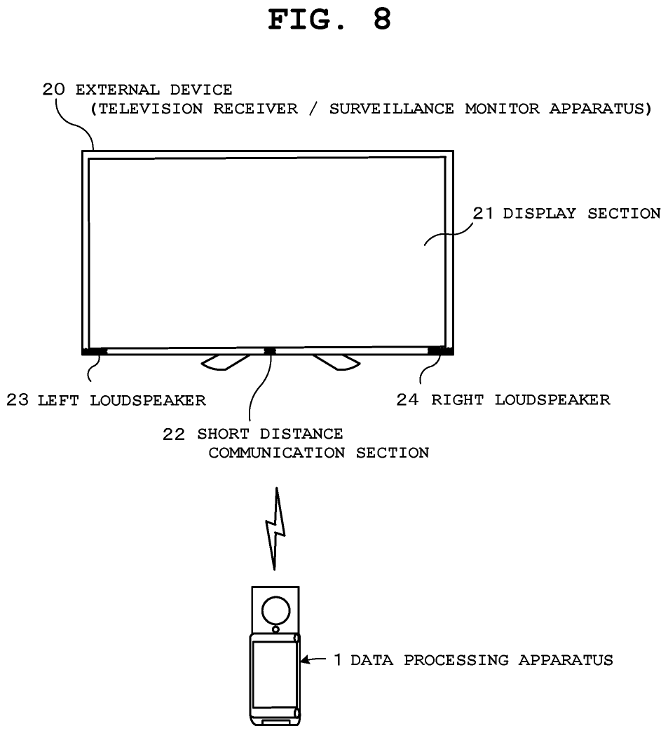

In the first to third embodiments described above, the digital camera has been described as the data processing apparatus 1 where the present invention has been applied. However, the data processing apparatus 1 may have a configuration where an external device is set as a data output destination and moving image data having audio data is transmitted to the external device. FIG. 8 is a diagram for describing the configuration where moving image data having audio data is transmitted to an external device 20 from the data processing apparatus 1 and outputted by the external device 20.

The external device 20 is, for example, a television receiver or a surveillance monitor apparatus, and includes a display section 21 for displaying image data, a short distance communication section 22 for performing data communication with the data processing apparatuses 1, a left loudspeaker 23 arranged at the lower left corner of the external device 20, and a right loudspeaker 24 arranged at the lower right corner of the external device 20. As this short distance communication, for example, wireless LAN (Wi-Fi) or Bluetooth (registered trademark) is used.

In this case, for example, the same configuration as the above-described first embodiment is applied to the data processing apparatus 1. As a result, on the data processing apparatus 1 side, the same operations as those of the flowchart in FIG. 4 are performed. In this case, at processing Step A9 in FIG. 4, the control section 11 performs processing of transmitting a clipped image to the external device 20 so that the external device 20 outputs the corresponding moving image data having audio data. Then, at processing Step A10, the control section 11 transmits the audio data of an audio source to the external device 20 together with volume control information determined for each loudspeaker, in synchronization with the transmission of the clipped image.

On the external device 20 side, the audio data is outputted from each loudspeaker at a determined sound volume based on the received volume control information. By this configuration where the large external device 20 is set as a data output destination, more impressive and dynamic output can be achieved. Note that a configuration may be adopted in which a processing step of creating a file for managing clipped audio and a clipped image corresponding thereto is newly provided to be performed after the above-described processing Step A6, the data processing apparatus 1 transmits the management file created at this new processing step to the external device 20, and the external device 20 outputs the image with voice by using the management file. In this case where the external device 20 is set as a data output destination, the same configuration as the second embodiment or the third embodiment may be applied to the data processing apparatus 1.

### Modification Example 3 of First to Third Embodiments

In the first to third embodiments described above, stereo output is achieved using the two loudspeakers (the first loudspeaker 7 and the second loudspeaker 8). However, for example, a configuration may be adopted in which loudspeakers of three or more channels are used to replay dynamic surround sound. In this configuration, a structure may be adopted in which, in addition to two-channel loudspeakers arranged in the horizontal direction (longer side direction) of a rectangular display screen, two-channel loudspeakers are arranged in the vertical direction (shorter side direction) of the display screen. Moreover, in this case, a configuration may be adopted in which whether to use the two loudspeakers arranged in the longer side direction or to use the two loudspeakers arranged in the shorter side direction is selected based on whether the rectangular display screen is in an orientation where it is vertically long (vertical orientation) or in an orientation where it is horizontally long (horizontal orientation). Furthermore, a structure may be adopted in which two-channel loudspeakers are arranged behind viewers of the screen.

Also, in the first to third embodiments, each loudspeaker is fixedly arranged with respect to the display screen. However, the present invention is not limited thereto, and a structure may be adopted in which each loudspeaker is movable to an arbitrary position with respect to a viewer. In this case, a structure may be adopted in which a relative positional relation between each loudspeaker and the display screen can be set by a user operation.

Moreover, in the first to third embodiments, recorded contents are outputted during the playback of moving image data. However, a configuration may be adopted in which recorded contents are outputted during the playback of a still image. In addition, the present invention is not limited to the configuration where recorded image data or recorded sound data is replayed, and a configuration may be adopted in which image data that is being captured or audio data that is being obtained is acquired via communication means and outputted on a real-time basis. Also, configurations of the above-described embodiments may be combined as necessary.

Furthermore, the data processing apparatus 1 is not limited to the separate-type digital camera (main body device 3) and may be, for example, a television receiver, a surveillance monitor apparatus, a personal computer, a PDA (Personal Digital Assistant), a tablet terminal device, a portable telephone such as a smartphone, an electronic game player, a musical player, or an electronic wristwatch.

Still further, the “apparatus” or the “sections” described in the above-described embodiments are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. A data processing apparatus comprising:
a processor,
wherein the processor performs processing of:
acquiring image data;
acquiring audio data;
analyzing the image data so as to identify a subject that is an audio source in the image data;
extracting specific audio data corresponding to the subject identified as the audio source from the acquired audio data; and
controlling such that the specific audio data and the subject are associated with each other.

2. The data processing apparatus according to claim 1, wherein the processor analyzes the audio data so as to acquire audio features, and analyzes the image data based on the audio features so as to identify the subject that is the audio source in the image data and having the audio features.

3. The data processing apparatus according to claim 1, wherein the processor identifies the subject that is the audio source by analyzing subjects in the image data, and analyzes the audio data based on appearance features of the subject identified as the audio source so as to extract the specific audio data corresponding to the subject having the appearance features from the audio data and control such that the specific audio data and the subject are associated with each other.

4. The data processing apparatus according to claim 1, wherein the processor identifies the subject that is the audio source by analyzing motions of subjects in the image data.

5. The data processing apparatus according to claim 3, wherein the processor identifies the subject that is the audio source by analyzing motions of the subjects in the image data.

6. The data processing apparatus according to claim 1, further comprising:
a display section which displays the image data,
wherein the processor displays, on the display section, image data including the subject identified as the audio source, and controlling such that the extracted specific audio data and the displayed subject are associated with each other.

7. The data processing apparatus according to claim 6, wherein the processor clips an area including the subject identified as the audio source from the acquired image data, and
wherein the processor (i) displays, on the display section, the clipped image acquired by the area being clipped, (ii) extracts, from the audio data, the specific audio data corresponding to the subject included in the clipped image as the audio source, and (iii) controls such that the specific audio data and the subject are associated with each other.

8. The data processing apparatus according to claim 6, wherein the processor clips an area including the subject arbitrarily specified as the audio source from the acquired image data, and
wherein the processor (i) displays, on the display section, the clipped image acquired by the area being clipped, (ii) extracts, from the audio data, the specific audio data corresponding to the subject included in the clipped image as the audio source, and (iii) controls such that the specific audio data and the subject are associated with each other.

9. The data processing apparatus according to claim 1, wherein the processor analyzes the audio data so as to extract audio data of each audio source, and
wherein the processor selects the specific audio data corresponding to the subject identified as the audio source from the extracted audio data of each audio source and controls such that the specific audio data and the subject are associated with each other.

10. The data processing apparatus according to claim 6, wherein the processor identifies the subject that is the audio source in the displayed image data by analyzing the image data displayed on the display section.

11. The data processing apparatus according to claim 1, further comprising:
an audio output section which outputs the specific audio data extracted from the audio data,
wherein the processor controls an output status of the specific audio data outputted from the audio output section in accordance with a position of the subject identified as the audio source in image of the image data.

12. The data processing apparatus according to claim 11, wherein the audio output section includes a plurality of loudspeakers arranged at different positions, and
wherein the processor controls, for each loud speaker, a sound volume of the specific audio data outputted from the audio output section in accordance with the position of the subject identified as the audio source.

13. The data processing apparatus according to claim 11, wherein the processor controls the output status of the specific audio data outputted from the audio output section based on a movement of the position of the subject identified as the audio source.

14. The data processing apparatus according to claim 11, wherein the processor controls the audio output section to output only the specific audio data corresponding to the subject identified as the audio source, and prevents output of other audio data.

15. The data processing apparatus according to claim 11, wherein the processor combines the specific audio data with other audio data and controls the audio output section to output resultant data.

16. The data processing apparatus according to claim 1, wherein the image data is image data acquired by wide-angle image capturing, and
wherein the audio data is audio data acquired by wide-range sound collection covering the wide angle being performed in synchronization with the wide-angle image capturing.

17. The data processing apparatus according to claim 1, wherein the processor controls such that the subject identified as the audio source and the specific audio data corresponding to the subject are associated with each other, and creates a file for managing image data including the subject and the specific audio data corresponding to the subject.

18. A data processing method for a data processing apparatus, comprising:
acquiring image data;
acquiring audio data;
analyzing the acquired image data so as to identify a subject that is an audio source in the image data;
extracting specific audio data corresponding to the subject identified as the audio source from the acquired audio data; and
controlling such that the specific audio data and the subject are associated with each other.

19. A non-transitory computer-readable storage medium having stored thereon a program that is executable by a computer in a data processing apparatus to actualize functions comprising:
acquiring image data;
acquiring audio data;
analyzing the acquired image data so as to identify a subject that is an audio source in the image data;
extracting specific audio data corresponding to the subject identified as the audio source from the acquired audio data; and
controlling such that the specific audio data and the subject are associated with each other.
